(19) United States
(12) Patent Application Publication
(10) Pub. No.: US 2005/0020169 A1
(43) Pub. Date: Jan. 27, 2005

(54) Warp knit having an excellent touch, and a process of preparing the same

(75) Inventor: Joon Young Yoon, Busan-city (KR)

Correspondence Address: Mark R. Shanks;REED SMITH, Suite 1100 - East Tower, 1301 K Street, N.W., Washington, DC, 20005-3373, US

(73) Assignee: Kolon Industries, Inc.

(21) Appl. No.: 10/883,695

(22) Filed: Jul. 6, 2004

Related U.S. Application Data
(63) Continuation of application No. 09/856,315, filed on May 21, 2001, now abandoned.

(30) Foreign Application Priority Data
Dec. 16, 1999 (KR) 1999/58119
Sep. 19, 2000 (KR) 2000/54839
Sep. 19, 2000 (KR) 2000/54840
Sep. 19, 2000 (KR) 2000-54836
Sep. 19, 2000 (KR) 2000-54837
Nov. 30, 2000 (WO) PCT/KR00/01196

(51) Int. Cl. B32B 27/12; D04B 1/18; D02G 3/00; D04B 7/16; D04B 11/12; D04B 21/14; D04B 1/14; D04B 7/00; D04B 1/22; D04B 7/24; D04B 9/24; D04B 21/20; D04B 7/14

(52) U.S. Cl. 442/306; 442/310; 442/312; 442/313; 428/365

(57) ABSTRACT

The present invention relates to a warp knit fabric having excellent touch and a process of preparing such a warp knit. The present invention provides a warp knit fabric having a technical face and a rear face, the technical face consisting of ultra fine yarn with monofilament denier of 0.01 to about 0.9 denier, the rear face consisting of synthetic yarn or high shrinkage yarn with monofilament denier of 1 to about 5 denier, wherein the recovery rate of elongation in the directions of wale and course is 8 to about 30%. The warp knit according to the present invention can be used to manufacture artificial leathers or ladies' clothes.

This application is a continuation-in-part of U.S. patent application Ser. No. 09/856,315 filed May 21, 2001.

### FIELD OF THE INVENTION

The present invention relates to a warp knit having excellent touch and a process for preparing such a warp knit. More particularly, the present invention relates to a warp knit designed to be exquisitely soft and having such draping property as would make it useful for the manufacture of articles such as ladies' clothes and artificial leathers.

### BACKGROUND OF THE INVENTION

Fine fibers tend to be soft to touch but also tend to have weak bending strength. Accordingly, there is active research aimed at developing commercial scale capabilities for the manufacture of fabrics comprising ultra fine fibers having very soft, sensitive touch. Development of technology capable of producing extremely fine synthetic yarns leads to great improvement in the value of the goods such as clothes comprising such sensitive materials.

Generally, the process of preparing ultra fine fiber is divided into three: a direct spinning process; a two-component division type spinning process; and a two-component extraction type spinning process. In the direct spinning process, it is possible to prepare ultra fine fiber of 0.3 to about 0.5 denier. In the two-component division type spinning process, it is possible to prepare ultra fine fiber of 0.2 denier or more. In the two-component extraction type spinning process, it is possible to prepare ultra fine fibers of 0.01 denier or less.

In the direct spinning process where the spinning and drawing are executed in a one-step process, the ultra fine fibers so prepared are warp knitted to very poor warping property and appearance since numerous filaments are scattered. Furthermore, the warp knit thus prepared is subjectively very inferior to touch and writing effect.

Furthermore, when ultra fine fibers consisting of nylon/polyester, prepared by means of the two-component division type composite spinning process, is warp knitted, warping and knitting properties of the warp knit is very poor since the nylon is isolated from the polyester as a result of the tension and friction in warping and knitting. Moreover, the appearance of the fabric is very poor due to denier limits of the ultra fine fiber.

On the other hand, when a composite fiber, such as nylon/polyester, of 0.05 denier or less prepared by means of the two-component extraction type spinning process is warp knitted, warping property, knitting property, and touch of the fabric are good. However, the density of the warp knit is adversely affected resulting in poor appearance since the extraction component is extracted at the extraction-processing step for producing the ultra fine fiber.

Generally, goods comprising ultra fine fiber are being produced in textile applications. However, in knitting applications, the poor warping property of ultra fine fibers and other processing drawbacks have limited the use of warp knitted ultra fine fibers.

Accordingly, it is an object of the present invention to prepare a warp knit comprising ultra fine fibers, with good warping and knitting properties, resulting in fabrics which have excellent touch, shape stability, and appearance, and thus suitable for materials such as ladies' clothes.

### SUMMARY OF THE INVENTION

The present invention provides yarns having good warping and knitting properties that can be warp knitted to produce a warp knit fabric that has excellent touch, shape stability, flexibility, and appearance, and is thus suitable for materials such as ladies' clothes. Shape stability is the property of retaining the clothes' shape without change.

More particularly, the present invention relates to a warp knit fabric having a technical face and a rear face, the technical face consisting of ultra fine yarn with monofilament denier of 0.01 to about 0.9 denier, the rear face consisting of synthetic yarn or high shrinkage yarn with monofilament denier of 1 to about 5 denier, wherein the recovery rate of elongation of the fabric in the directions of wale and course is 8 to about 30%.

The present invention also relates to a process for preparing a warp knit fabric having excellent touch, comprising knitting a composite fiber consisting of a fiber-forming component of 0.01 to about 0.9 denier and an extraction component, as the yarn of the technical face, and a synthetic yarn or high shrinkage yarn with monofilament of 1 to about 5 denier as the yarn of the rear face. The warp knit fabric is then raised until the shrinkage rate of the warp knit has reached 40% or more, and then pre-heating the warp knit fabric, extracting the extraction component from the composite fiber, dyeing, buffing, and finally heating treating the warp knit, preferably in a Tenter Machine, to set the shape of the warp knit. It is also understood by one of skill in the art that raising is done to improve both the appearance of the warp knit and to achieve a desired shrinkage rate.

### BRIEF DESCRIPTION OF THE DRAWINGS

FIG. 1 is a graph showing the recovery rate of elongation of a warp knit of the present invention measured using an Instron tester designed for testing elongation and strength of yarn.

### DETAILED DESCRIPTION OF THE INVENTION

Reference will now be made in detail to the preferred embodiments of the invention. This invention may, however, be embodied in many different forms and should not be construed as limited to the embodiments set forth herein. In addition and as will be understood by one of skill in the art, the invention may be embodied as a product, method, system or process.

The selection and combination of materials in designing the structure of fabrics is very important in order to prepare polyester warp knit fabric which is as soft as natural suede, and which has excellent appearance as well as having excellent warping and knitting properties.

The present invention uses a composite fiber, consisting of fiber-forming component of 0.01 to about 0.9 denier and an extraction component, as a yarn of the technical face. When the extraction component is removed from the composite fiber, the fiber-forming component with monofilament denier of 0.01 to about 0.9 denier is left. If the monofilament denier of the yarn of the technical face is more than 0.9 denier, its soft touch is poor and the writing effect is not revealed. If the monofilament denier of the yarn of the technical face is less than 0.01 denier, its soft touch is maintained, but its appearance is poor since raised fibers fall off the warp knit or are entangled due to friction.

It is preferable that the density of the yarn at the technical face is increased in order to improve the touch of the warp knit. It is possible for increasing the density of the yarn at the technical face to reduce the content of the extraction component in the composite fiber during the manufacturing phase of the composite fiber; however, the content of the extraction component is curbed technically during the spinning process. Spinning process refers to the standard process of extruding a melted polymer through a nozzle and drawing those for manufacturing yarns. There are limitations to increasing the density of the yarn of the technical face even if the content of the extraction component in the composite fiber is reduced.

It is more preferable for increasing the density of the fiber of the technical face to use high shrinkage yarn as the yarn of the rear face. If the shrinkage rate of the yarn of the rear face is high, the warp knit is more contracted. As a result, the density of the fibers of the technical face is increased.

WO 02/42528, assigned to Kolon Industries, Inc., describes the process of preparing composite fibers of the sea-island type used in preparing the ultra fine yarns of the technical face of the present invention. WO 02/42528 is hereby incorporated in its entire by reference.

The quantity of the extraction component in the composite fiber is generally 20 to about 40% by weight. It is preferable that polyester is used as the fiber-forming component and copolyester, with excellent alkali hydrolysis property, is used as the extraction component of the composite fiber.

With respect to the rear face of the warp knit fabric, synthetic yarn or high shrinkage yarn with monofilament denier of 1 to about 5 denier is used. If the monofilament denier of the yarn at the rear face is less than 1 denier, draping property of the warp knit decreases. If the monofilament denier of the yarn at the rear face is more than 5 denier, warping property and knitting property of the warp knit fabric deteriorates.

The high shrinkage yarn, which is used as the yarn of the rear face, preferably has a shrinkage rate in boiling water of 15 to about 50% at the stress of heat shrinkage of 0.2 grams/denier or more. If the shrinkage rate of the high shrinkage yarn in boiling water is less than 15%, it is not possible to increase the density of ultra fine yarn of the technical face, leading to poor touch. If the shrinkage rate of the high shrinkage yarn in boiling water is more than 50%, it is possible to increase the density of ultra fine yarn of the technical face; however, it is hard to control the process width of the finished warp knit since the shrinkage is extremely high.

Copolyester is preferably used as the high shrinkage yarn mentioned above. Co-polymer components include bisphenol-A, polyethyleneglycol, isophthalic acid or the like. However, the present invention is not limited to any particular co-polymer component of the high shrinkage yarn.

Also, the present invention uses a synthetic yarn with monofilament denier of 1 to about 5 denier as the yarn of the rear face. The synthetic yarn can be a polyester filament or polyamide filament, preferably polyester filament. If the monofilament denier of the yarn at the rear face is less than 1 denier, it is impossible to add proper repulsion to the warp knit fabric. If the monofilament denier of the yarn at the rear face is more than 5 denier, the process of warping and knitting are difficult, and the touch of the warp knit deteriorates due to increased repulsion of warp knit fabric.

The yarn content of the rear face when knitted is preferably 15 to about 60% by weight of the total weight of the processed warp knit. If the content of the yarn of the rear face is less than 15% in weight, draping property deteriorates. If the content of the yarn of the rear face is more than 60% by weight, touch deteriorates.

The yarn content of the technical face when it is knitted is preferably 40 to about 85% by weight of the total weight of the processed warp knit. If the content of the yarn of the technical face is less than 40% by weight, the touch of the warp knit is poor. If the content of the yarn of the technical face is more than 85% in weight, the draping property and the mechanical property of the warp knit deteriorates.

The present invention is further characterized in that the raw warp knit described above may be raised so that the shrinkage rate of the raw warp knit is 40% or more before preliminary heat treatment in a Tenter. Raising is carried out by means of a raising machine, at room temperature, and about eight passes in the raising machine would achieve a shrinkage rate of 40% or more.

Raising is the production of protruding fibers on the technical surface of the fabric by brushing. The fabric in open width, is passed between rotating rollers covered with teazels, fine wire, Carborundum, etc., whereby the surface fibers are pulled out or broken to give the required effect, such as suede effect, peach skin effect, etc.

The fabric finishing steps of the present invention typically involve raising, then preliminary heat-treatment, and further treatment in an alkali solution, whereby the extraction component is removed from the composite fiber. NaOH is the preferred alkali and extraction is carried out by immersing the fabric in the alkali solution at about 98° C. for about 30 minutes. After that, the warp knit is dyed, buffed and finally heat-treated. A second heat treatment may be carried out at 170° C. at 30 m/min in a Tenter and a final heat treatment may be carried out at 180-190° C. at 30 m/min.

The finishing operation is the final step in producing fabrics and typically imparts the aesthetic and physical properties required for various fabric uses. These properties, achieved through a combination of chemical and mechanical processes, include shrinkage control, stain resistance, water repellency, and softness. Conventional technologies may be used. In one embodiment, the raw warp knit is immersed in a solution of 1-2 wt % NaOH at 98° C. for 30 minutes in order to remove the extraction component. The length of exposure to NaOH depends on the desired weight reduction. If a lower temperature is desired, a 3-5 wt % NaOH may be used at 65° C. for 70 minutes. Once this is done, the fabric is removed and excess moisture is squeezed out mechanically. The moisture may be further reduced by a vacuum system before the fabric is directed to a fabric drying equipment such as a Tenter frame. The Tenter frame removes the remaining moisture by passing the fabric through a series of nozzles that expose it to hot air.

The preliminary heating, the fabric drying after alkali hydrolysis of the extraction component, and the final heating can all be Tenter processes. In one embodiment, an eight chamber Tenter process may be used under standard Tenter control conditions such as at the desired temperature at 30 m/min and fabric residence time of about 1 minute. For a four chamber Tenter, speed may be halved accordingly.

As the present invention uses the extraction type composite fiber as the yarn of the technical face, the warping and knitting property is excellent. Also, as the extraction component of the composite fiber is extracted after the warp knitting, the yarn of the technical face is fined for improving excellent touch and writing effect. Writing effect means that it is possible to write on the fabric using hand held writing devices.

Meanwhile, the warp knit fabric of the present invention comprises ultra fine yarn with monofilament denier of 0.01 to about 0.9 denier, whereby its touch and appearance are very excellent as determined by the subjective assessment of a panel of practitioners in the art. Particularly, as the warp knit fabric of the present invention includes the rear face consisting of high shrinkage yarn with 15 to about 50% shrinkage rate in boiling water, the density of the ultra fine yarn of the technical face is high, and recovery rate of elongation of the warp knit in the directions of the wale and the course is 8 to about 30%. Also, as the warp knit of the present invention includes 15 to about 60% by weight of the rear face consisting of the high shrinkage yarn, the touch and the draping property of the warp knit are excellent. The recovery rate of elongation is basically affected by the degree of raising process, the shrinkage rate of the yarn of the rear face, the time and temperature of heat treatment. For instance, if the raising process is severe, the recovery rate of elongation increases because the severe raising process contracts the warp knit fabric.

Further, when the warp knit of the present invention uses synthetic yarn with suitable denier as the yarn of the rear face, the problem of touch of the warp knit prepared by the two component extraction fiber being too soft is effectively resolved. Monofilament denier of 1 to about 5 is preferred as the yarn of the rear face. Such a warp knit has excellent draping property and raising property.

A two-bar warp knitting process prepares the preferred fabric. For instance, the warp knit fabric of the present invention can be produced by feeding the ultra fine yarn wound on the first beam of the first feeding bar (L1), and the synthetic yarn wound on the second beam of the second feeding bar (L2) of the two bar warp knitting machine such that the yarn passing the L1 feeding bar constitutes the technical face, and the yarn passing the L2 feeding bar constitutes the rear face, wherein the yarns of the two faces are bound together by a common knot.

The present invention is not limited to any knitting pattern. Any knitting pattern such that the ultra fine yarn constitutes the technical face and the high shrinkage yarn constitutes the rear face, with the raising and appropriate finishing steps fallen within the scope of this invention will produce the exquisite touch and effect of the warp knit fabric of this invention.

As described in detail above, the warp knit of the present invention has excellent touch, appearance, and draping property, and is thus suitable for materials of ladies' clothes or artificial leathers.

The properties of the warp knit of the present invention are evaluated as follows:

Softness

Softness of the warp knit is evaluated by sensitivity examinations of ten specialists. If more than eight specialists determine that the warp knit is soft, it is excellent. If five to about seven specialists determine that the warp knit is soft, it is good. If more than eight specialists determine that the warp knit is not soft, it is poor.

Draping Property

Draping property of the warp knit is evaluated by sensitivity examination of ten specialists. If more than eight specialists determine that the warp knit has draping property, it is excellent. If five to about seven specialists determine that the warp knit has draping property, it is good. If more than eight specialists determine that the warp knit has poor draping property, it is poor.

Writing Effect

Writing effect of the warp knit is evaluated by sensitivity examination of ten specialists. If more than eight specialists determine that the warp knit has writing effect, it is excellent. If five to about seven specialists determine that the warp knit has writing effect, it is good. If more than eight specialists determine that the warp knit has poor writing effect, it is poor.

Appearance

Appearance of the warp knit is evaluated by sensitivity examination of ten specialists. If more than eight specialists determine that the warp knit has good appearance, it is excellent. If five to about seven specialists determine that the warp knit has good appearance, it is good. If more than eight specialists determine that the warp knit has poor appearance, it is poor.

Shrinkage Rate in Boiling Water

Shrinkage rate in boiling water is measured according to JIS-L-1073 methods.

Recovery Rate of Elongation (%) of the Warp Knit Fabric.

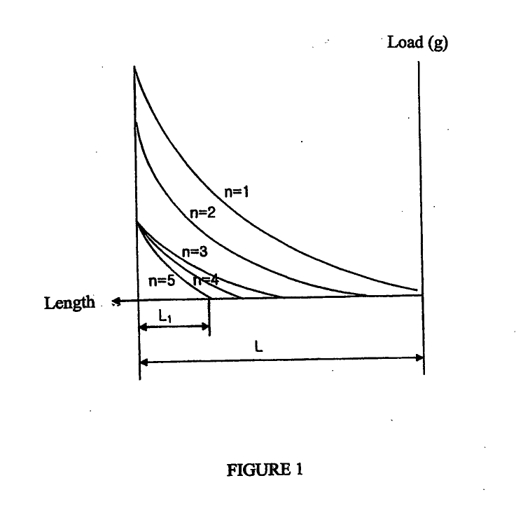

Total measurement is carried out according to KSK 08125, but proper elongation length at constant velocity is measured by using JIS L 1096. Both ends of a sample of the warp knit fabric with length of 10 cm and width of 15 cm are fixed to Instron. The warp knit is elongated constantly at the stretching velocity of 100 nun/min until a load of 750 g is reached. The warp knit is left as it is with the load being removed. Next, the warp knit is elongated at the constant velocity of 100 mm/min up to the original position. Then, the warp knit is left as it is for three minutes with the load being removed. The above process is repeated five times. Finally, the elongated length L, and the free elongated length L₁, are measured. The free elongated length L₁ is obtained by subtraction of the length measured after the warp knit is left as it is from the elongated length L (See FIG. 1). The recovery rate of elongation is obtained by putting the elongated length (L) and the free elongated length (L₁) in the following equation:
Recovery rate of elongation (%)=[elongated length (L)−free elongated length (L₁)]/elongated length (L)×100

Warping Property

Warping property is evaluated by checking the stop times/hour of the warping machine due to yarn defect. If the stop times/hour is zero, it is excellent. If the stop times/hour is one or two, it is good. If the stop times/hour is more than 3 times, it is poor. The stop times/hour of the warping machine is calculated by dividing the total stop times of warping machine in warping a yarn of 9 kg by the total warping time.

Knitting Property

Knitting property is evaluated by checking the stop times/hour of the knitting machine due to yarn defect. If the stop times/hour is zero, it is excellent. If the stop times/hour is one or two, it is good. If the stop times/hour is more than 3 times, it is poor. The stop times/hour of knitting machine is calculated by dividing the total stop times of the knitting machine in a day by 24 hours.

Raising Property

The raising property of the warp knit is evaluated by sensitivity examination. If the raising of the warp knit is finished well by passing through the raising machine 8 times at speed of 15 m/minute, it is excellent. If the raising of the warp knit is finished well by passing through the raising machine 10 times at speed of 15 m/minute, it is good. If the raising of warp knit is finished well by passing through the raising machine more then 10 times at speed of 15 m/minute, it is poor.

The present invention is now understood more concretely by comparison between examples of the present invention and comparative examples. However, the present invention is not limited to such examples.

### EXAMPLE 1

First, a raw warp knit with density of 23 course/centimeter is prepared. For the technical face, an extraction type composite fiber in which the fiber forming component is polyethyleneterephtalate, and the extraction component is copolyester copolymerized with 7 mole % dimethylene sulfurisophthalic sodium, is used to prepare a 0.05 denier of ultra fine yarn determined after removing the extraction component as stated below. For the rear face, a copolyester yarn with monofilament of 5 denier and shrinkage rate in boiling water of 28% (high shrinkage yarn) is used. At this time, the yarn content of the rear face is 26% by weight of the total weight of fully processed warp knit. Next, the manufactured raw warp knit is passed through a raising machine until the shrinkage rate in boiling water of the warp knit has reached 50%. Then, the warp knit is heated at 150° C., at 30 m/min by passing through a heating chamber and dipped in a solution of 1% NaOH for 30 minutes at 98° C. in order to remove the extraction component of the composite fiber. Finally, the processed warp knit is prepared by dyeing (with disperse dyes), buffing and heating at 180° C. at 30 meters/minute. After that, the properties of the processed warp knit are evaluated using the above-mentioned methods. The results of the evaluation are shown in Table 1.

### EXAMPLE 2

First, a raw warp knit with density of 23 course/centimeter is prepared. For the technical face, an extraction type composite fiber in which the fiber forming component is polyethyleneterephtalate, and the extraction component is copolyester copolymerized with 7 mole % dimethylene sulfirisophthalic sodium, is used to prepare a 0.07 denier of ultra fine yarn determined after removing the extraction component as stated below. For the rear face, a copolyester yarn with monofilament of 3 denier and shrinkage rate in boiling water of 34% (high shrinkage yarn) is used. At this time, the yarn content of the rear face is 31% by weight of the total weight of fully processed warp knit. Next, the manufactured raw warp knit is passed through a raising machine until the shrinkage rate in boiling water of the warp knit has reached 55%. Then, the warp knit is heated at 190° C., at 30 m/min by passing through a heating chamber and dipped in a solution of 1% NaOH for 30 minutes at 98° C. in order to remove the extraction component of the composite fiber. Finally, the processed warp knit is prepared by dyeing (with disperse dyes), buffing and heating at 180° C. at 30 m/min. After that, the properties of the processed warp knit are evaluated using the above-mentioned methods. The results of the evaluation are shown in Table 1.

### EXAMPLE 3

First, a raw warp knit with density of 23 course/centimeter is prepared. For the technical face, an extraction type composite fiber in which the fiber forming component is polyethyleneterephtalate, and the extraction component is copolyester copolymerized with 7 mole % dimethylene sulfurisophthalic sodium, is used to prepare a 0.04 denier of ultra fine yarn determined after removing the extraction component as stated below. For the rear face, a copolyester yarn with monofilament of 2.5 denier and shrinkage rate in boiling water of 28% (high shrinkage yarn) is used. At this time, the yarn content of the rear face is 55% by weight of the total weight of fully processed warp knit. Next, the manufactured raw warp knit is passed through a raising machine until the shrinkage rate in boiling water of the warp knit has reached 50%. Then, the warp knit is heated at 190° C., at 30 m/min by passing through a heating chamber and dipped in a solution of 1% NaOH for 30 minutes at 98° C. in order to remove the extraction component of the composite fiber. Finally, the processed warp knit is prepared by dyeing (with disperse dyes), buffing and heating at 180° C. at 30 m/min. After that, the properties of the processed warp knit are evaluated using the above-mentioned methods. The results of the evaluation are shown in Table 1.

### EXAMPLE 4

First, a raw warp knit with density of 23 course/centimeter is prepared. For the technical face, an extraction type composite fiber in which the fiber forming component is polyethyleneterephtalate, and the extraction component is copolyester copolymerized with 7 mole % dimethylene sulfirisophthalic sodium, is used to prepare a 0.2 denier of ultra fine yarn determined after removing the extraction component as stated below. For the rear face, a copolyester yarn with monofilament of 5 denier and shrinkage rate in boiling water of 28% (high shrinkage yarn) is used. At this time, the yarn content of the rear face is 26% by weight of the total weight of fully processed warp knit. Next, the manufactured raw warp knit is passed through a raising machine until the shrinkage rate in boiling water of the warp knit has reached 55%. Then, the warp knit is heated at 190° C., at 30 m/min by passing through a heating chamber and dipped in a solution of 1% NaOH for 30 minutes at 98° C. in order to remove the extraction component of the composite fiber. Finally, the processed warp knit is prepared by dyeing (with disperse dyes), buffing and heating at 180° C. at 30 m/min. After that, the properties of the processed warp knit are evaluated using the above-mentioned methods. The results of the evaluation are shown in Table 1.

### COMPARATIVE EXAMPLE 1

First, a raw warp knit with density of 23 course/centimeter is prepared. For the technical face, an extraction type composite fiber in which the fiber forming component is polyethyleneterephtalate, and the extraction component is copolyester copolymerized with 7 mole % dimethylene sulfurisophthalic sodium, is used to prepare a 0.05 denier of ultra fine yarn determined after removing the extraction component as stated below. For the rear face, a copolyester yarn with monofilament of 0.5 denier and shrinkage rate in boiling water of 40% (high shrinkage yarn) is used. At this time, the yarn content of the rear face is 48% by weight of the total weight of fully processed warp knit. Next, the manufactured raw warp knit is passed through a raising machine until the shrinkage rate in boiling water of the warp knit has reached 50%. Then, the warp knit is heated at 190° C., at 30 m/min by passing through a heating chamber and dipped in a solution of 1% NaOH for 30 minutes at 98° C. in order to remove the extraction component of the composite fiber. Finally, the processed warp knit is prepared by dyeing (with disperse dyes), buffing and heating at 180° C. at 30 m/min After that, the properties of the processed warp knit are evaluated using the above-mentioned methods. The results of the evaluation are shown in Table 1.

### COMPARATIVE EXAMPLE 2

First, a raw warp knit with density of 23 course/centimeter is prepared. For the technical face, an extraction type composite fiber in which the fiber forming component is polyethyleneterephtalate, and the extraction component is copolyester copolymerized with 7 mole % dimethylene sulfirisophthalic sodium, is used to prepare a 0.05 denier of ultra fine yarn determined after removing the extraction component as stated below. For the rear face, a polyester yarn with monofilament of 20 denier is used. At this time, the yarn content of the rear face is 42% by weight of the total weight of fully processed warp knit. Next, the manufactured raw warp knit is passed through a raising machine until the shrinkage rate in boiling water of the warp knit has reached 50%. Then, the warp knit is heated at 190° C., at 30 m/min by passing through a heating chamber and dipped in a solution of 1% NaOH for 30 minutes at 98° C. in order to remove the extraction component of the composite fiber. Finally, the processed warp knit is prepared by dyeing (with disperse dyes), buffing and heating at 180° C. at 30 m/min. After that, the properties of the processed warp knit are evaluated using the above-mentioned methods. The results of the evaluation are shown in Table 1.

### COMPARATIVE EXAMPLE 3

First, a raw warp knit with density of 23 course/centimeter is prepared. For the technical face, an extraction type composite fiber in which the fiber forming component is polyethyleneterephtalate, and the extraction component is copolyester copolymerized with 7 mole % dimethylene sulfurisophthalic sodium, is used to prepare a 1.3 denier of ultra fine yarn determined after removing the extraction component as stated below. For the rear face, a polyester yarn with monofilament of 20 denier is used. At this time, the yarn content of the rear face is 42% by weight of the total weight of fully processed warp knit. Next, the manufactured raw warp knit is passed through a raising machine until the shrinkage rate in boiling water of the warp knit has reached 50%. Then, the warp knit is heated at 190° C., at 30 m/min by passing through a heating chamber and dipped in a solution of 1% NaOH for 30 minutes at 98° C. in order to remove the extraction component of the composite fiber. Finally, the processed warp knit is prepared by dyeing (with disperse dyes), buffing and heating at 180° C. at 30 m/min. After that, the properties of the processed warp knit are evaluated using the above-mentioned methods. The results of the evaluation are shown in Table 1.

### COMPARATIVE EXAMPLE 4

Except for using ultra fine polyester yarn with monofilament of 0.04 denier, made by direct spinning, as the yarn of the technical face, a warp knit is prepared by the same process and conditions as in Example 1. And then, the properties of the processed warp knit are evaluated as in the above-mentioned methods. The results of the evaluation are shown in Table 1.

TABLE 1
Results of property evaluation of warp knit

| | | Example | | | | Comparative example | | | |
|---|---|---|---|---|---|---|---|---|---|
| Class | | 1 | 2 | 3 | 4 | 1 | 2 | 3 | 4 |
| Softeness | | E | E | E | E | G | P | P | E |
| Draping property | | E | E | E | G | P | E | G | G |
| Writing effect | | E | E | E | E | E | P | P | P |
| Appearance | | E | E | G | G | G | G | P | G |
| Warping property | | E | E | E | E | E | E | G | P |
| Knitting property | | E | E | E | E | G | E | E | P |
| Raising property | | G | G | G | E | G | G | P | P |
| Recovery | In the | 20.01 | 12.36 | 18.00 | 16.27 | 19.77 | 10.40 | 14.88 | 7.87 |
| rate of | direction | | | | | | | | |
| elongation | of wale | | | | | | | | |
| (%) | In the | 18.57 | 13.00 | 15.23 | 15.33 | 17.23 | 13.26 | 16.29 | 6.90 |
| | direction | | | | | | | | |
| | of course | | | | | | | | |

(The E means excellent, G means good and P means poor in the Table 1)

As described above, the warp knit fabric of the present invention has excellent touch, appearance, shape stability rate, draping property, and thus is useful for materials of artificial leathers or ladies' clothes. Furthermore, the process of preparing such a warp knit according to the present invention gives the warp knit very excellent warping property and knitting property.

1. A warp knit having a technical face and a rear face, the technical face consisting of ultra fine yarn with monofilament denier of 0.01 to about 0.9 denier post extraction, the rear face consisting of synthetic yarn with monofilament denier of 1 to about 5 denier, wherein the recovery rate of elongation in the directions of wale and course is 8 to about 30%, wherein the ultra fine yarn is raised.

2. The warp knit of claim 1, wherein the ultra fine yarn is polyester or polyamide.

3. The warp knit of claim 1, wherein the content of the ultra fine yarn constituting the technical face is 40 to about 85% in weight of the total weight of the processed warp knit.

4. The warp knit of claim 1, wherein the content of the synthetic yarn constituting the rear surface is 15 to about 60% in weight of the total weight of the processed warp knit.

5. The warp knit of claim 1, wherein the synthetic yarn is copolyester yarn with 15 to about 50% shrinkage rate in boiling water.

6. The warp knit of claim 1, wherein the synthetic yarn is polyester or polyamide.

7. A process of preparing a warp knit comprising the steps of:
knitting a raw warp knit using a composite fiber consisting of a fiber-forming component of 0.01 to about 0.9 denier post extraction, and an extraction component as the yarn of the technical face, and a synthetic yarn or high shrinkage yarn with monofilament of 1 to about 5 denier as the yarn of the rear face;
raising the warp knit until the shrinkage rate of the warp knit reaches 40% or more;
heating the raising-treated warp knit to condition it for further processing;
extracting the extraction component from the composite fiber by means of alkali hydrolysis;
finishing the warp knit by dyeing, buffing, and a second heating.

8. The process of claim 7, wherein the weight ratio of the yarn of the technical face to the yarn of the rear face is 40-85% to 15-60% in weight.
